(19) United States
(12) Patent Application Publication
(10) Pub. No.: US 2013/0160594 A1
(43) Pub. Date: Jun. 27, 2013

(54) Telescoping Jacket Interface Mechanism

(71) Applicant: Melvin Lee Tinnin, Clio, MI (US)

(72) Inventor: Melvin Lee Tinnin, Clio, MI (US)

(73) Assignee: NEXTEER (BEIJING) TECHNOLOGY CO., LTD., Saginaw, MI (US)

(21) Appl. No.: 13/333,161

(22) Filed: Dec. 21, 2011

(51) Int. Cl. B62D 1/184

(52) U.S. Cl. 74/493

(57) ABSTRACT

A steering column assembly is provided, and includes an inner jacket, an outer jacket, and a bracket. The inner jacket has an inner jacket outer surface. The outer jacket has an outer jacket outer surface. The inner jacket is slideably disposed in the outer jacket for telescoping movement relative to the outer jacket. The outer jacket has at least one aperture for exposing the inner jacket outer surface. The bracket has at least one inner jacket riser and at least one outer jacket riser. The inner jacket riser is positioned to be received by the at least one aperture and selectively frictionally engage with the inner jacket outer surface. The outer jacket riser is positioned to selectively frictionally engage with the outer jacket outer surface.

### FIELD OF THE INVENTION

The present invention relates to a steering column assembly and in particular to a steering column assembly having an inner jacket, an outer jacket, and a bracket that selectively frictionally engages with the inner jacket and the outer jacket.

### BACKGROUND OF THE INVENTION

Steering column assemblies that are adjustable in a rake direction and a telescoping direction typically rely on a friction locking system to maintain a selected position of adjustment during operation. A steering column assembly may include inner and outer telescoping jackets, a compression bracket, a rake bracket, and a steering wheel. The compression bracket is engaged with either the inner jacket or the outer jacket, and the rake bracket is usually compressed against the compression bracket to provide a friction lock.

A bushing, which is typically constructed from a polymer, may be disposed inside the outer jacket and is used to delash the sliding interface between the inner jacket and the outer jacket. The bushing also provides a frictional force that is overcome before the steering column telescopes. Specifically, the frictional force may be overcome by a user pushing or pulling on the steering wheel.

One issue with the current approach of employing the bushing is that the frictional force may sometimes be difficult to control, especially because the bushing is typically constructed from a polymer material. Specifically, there is a balance between the material stiffness of the polymer and a relatively low friction force for adjusting the steering wheel. It is usually beneficial for steering column assemblies to include a relatively low frictional force that a user overcomes to telescope the steering column. However, if a bushing has a relatively low friction force, then the material stiffness will be adversely affected. Likewise, a bushing with high stiffness will in turn also have a relatively high friction force that is needed to adjust the steering column.

### SUMMARY OF THE INVENTION

A steering column assembly is provided, and includes an inner jacket, an outer jacket, and a bracket. The inner jacket has an inner jacket outer surface. The outer jacket has an outer jacket outer surface. The inner jacket is slideably disposed in the outer jacket for telescoping movement relative to the outer jacket. The outer jacket has at least one aperture for exposing the inner jacket outer surface. The bracket has at least one inner jacket riser and at least one outer jacket riser. The inner jacket riser is positioned to be received by the at least one aperture and selectively frictionally engage with the inner jacket outer surface. The outer jacket riser is positioned to selectively frictionally engage with the outer jacket outer surface.

In another embodiment, a steering column assembly is provided having an inner jacket, an outer jacket, a rake bracket, and a compression bracket. The inner jacket has an inner jacket outer surface. The outer jacket has an outer jacket outer surface. The inner jacket is slideably disposed in the outer jacket for telescoping movement relative to the outer jacket. The outer jacket has at least one aperture for exposing the inner jacket outer surface. The compression bracket is selectively compressed by the rake bracket. The compression bracket has at least one inner jacket riser and at least one outer jacket riser. The at least one inner jacket riser is positioned to be received by the at least one aperture and frictionally engage with the inner jacket outer surface if the compression bracket is compressed by the rake bracket. The at least one outer jacket riser is positioned to frictionally engage with the outer jacket outer surface if the compression bracket is compressed by the rake bracket. The at least one inner jacket riser exerts a specified frictional force if the compression bracket is compressed by the rake bracket.

In yet another embodiment, an assembly is provided having an inner jacket, an outer jacket, and a bracket. The inner jacket has an inner jacket outer surface. The outer jacket has an outer jacket outer surface. The inner jacket is slideably disposed in the outer jacket for telescoping movement relative to the outer jacket. The outer jacket has at least one aperture for exposing the inner jacket outer surface. The bracket has at least one inner jacket riser and at least one outer jacket riser. The at least one inner jacket riser is positioned to be received by the at least one aperture and selectively frictionally engage with the inner jacket outer surface. The at least one outer jacket riser is positioned to selectively frictionally engage with the outer jacket outer surface.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an illustration of an exemplary steering column in accordance with the invention;

FIG. 2 is a cross-sectional view of the steering column shown in FIG. 1 along section A-A;

FIG. 3 is a view of another aspect of the invention;

FIG. 4 is a view of yet another aspect of the invention;

FIG. 5 is a view of still yet another aspect of the invention illustrating a compression bracket of the steering column assembly shown in FIG. 1; and

FIGS. 6A-6B illustrate alternative embodiments of the compression bracket shown in FIG. 5.

### DETAILED DESCRIPTION

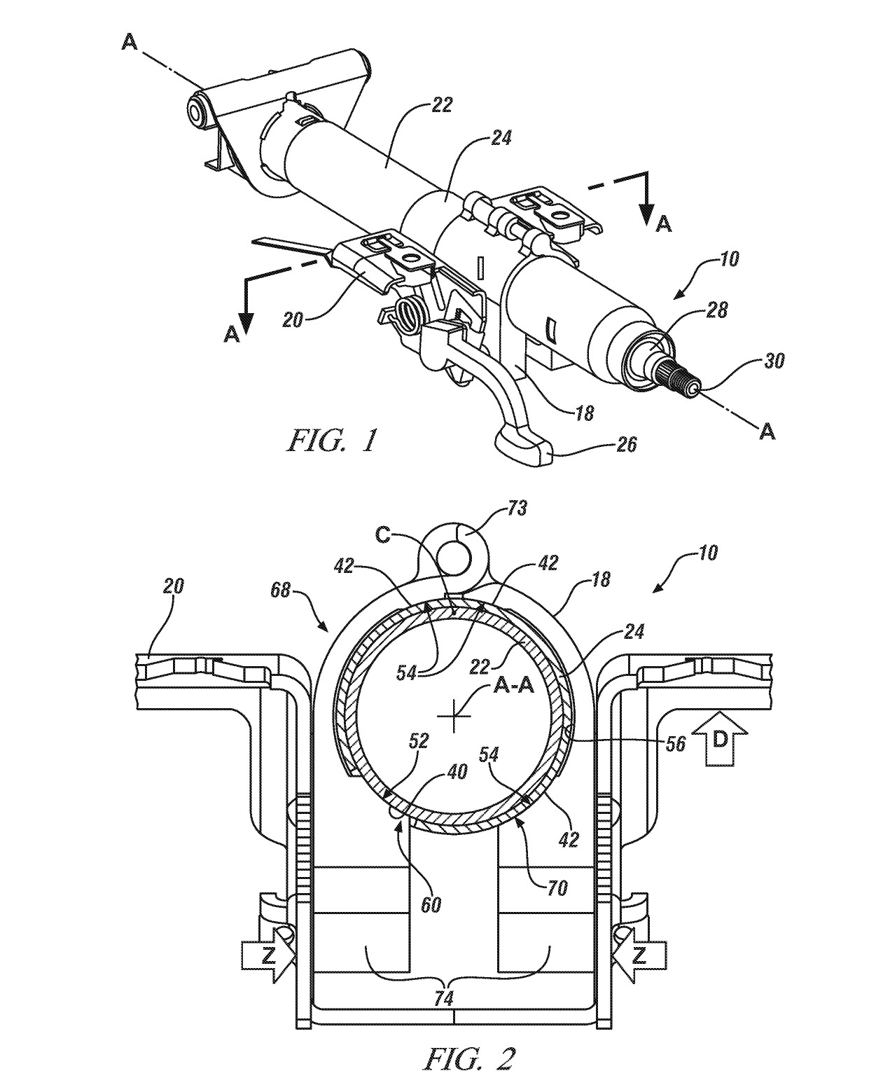

Referring now to the Figures, where the invention will be described with reference to specific embodiments, without limiting same, FIG. 1 illustrates a steering column assembly 10 in accordance with one aspect of the invention. In the exemplary embodiment shown, the steering column assembly 10 includes a compression bracket 18, a rake bracket 20, an inner jacket 22, an outer jacket 24, a lever 26, and a steering shaft 28. The steering shaft 28 includes a distal end 30. The distal end 30 of the steering shaft 28 attaches to a steering wheel (not shown). The inner jacket 22 and the outer jacket 24 both extend along a longitudinal axis A-A. The inner jacket 22 is slideably disposed in the outer jacket 24 for telescoping movement along the longitudinal axis A-A relative to the outer jacket 24. Although FIGS. 1-6B illustrate a steering column 10, it is to be understood that the invention may be used in a variety of different applications having telescoping inner and outer jackets. For example, the assembly as shown in FIG. 1 may be employed in an adjustable height seat or adjustable length tools.

FIG. 2 is a cross-sectional view of the steering column 10 along section A-A shown in FIG. 1. In the embodiment as shown in FIG. 2, the rake bracket 20 is selectively compressed inwardly towards the longitudinal axis A-A in a direction Z. The rake bracket 20 may be compressed in the direction Z by any type of mechanism such as, for example, a cam mechanism (not shown in FIG. 2). Specifically, the rake bracket 20 is selectively compressed inwardly in the direction Z, which in turn compresses the compression bracket 18. Compression of the compression bracket 18 in the direction Z will in turn restrict or substantially present telescoping movement of the inner jacket 22 relative to the outer jacket 24 along the longitudinal axis A-A (shown in FIG. 1). The compression bracket 18 selectively frictionally engages with a portion of an outer surface 40 of the inner jacket 22 and a portion of an outer surface 42 of the outer jacket 24. Specifically, when the compression bracket 18 is compressed in the direction Z by the rake bracket 20, the outer surface 40 of the inner jacket 22 and the outer surface 42 of the outer jacket 24 are frictionally engaged with the compression bracket 18.

Referring to both FIGS. 2-5, the compression bracket 18 includes a plurality of risers 52 and 54 configured for selectively frictionally engaging with the inner jacket 22 and the outer jacket 24. In the embodiment as illustrated, the compression bracket 18 includes a generally U-shaped configuration, however it is to be understood that the compression bracket 18 may include other configurations as well. The compression jacket 18 includes at least one inner jacket riser 52 and at least one outer jacket riser 54 disposed along an inner surface 56 of the compression bracket 18. In the embodiment as shown, the risers 52 and 54 are platforms or areas that are elevated above the inner surface 56 of the compression bracket 18. The inner jacket risers 52 are configured to selectively frictionally engage with the outer surface 40 of the inner jacket 22, and the outer jacket risers 54 are configured to selectively frictionally engage with the outer surface 42 of the outer jacket 24 as well. Engagement of the inner jacket risers 52 with the outer surface 40 of the inner jacket 22 and the engagement of the outer jacket risers 54 with the outer surface 42 of the outer jacket 24 is shown in FIG. 2.

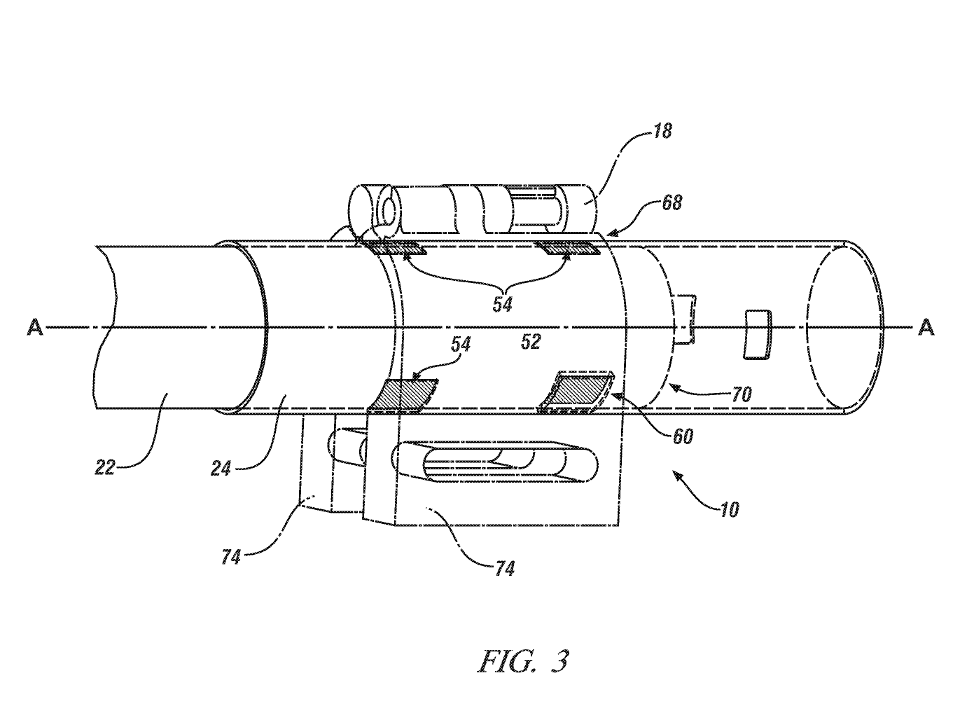

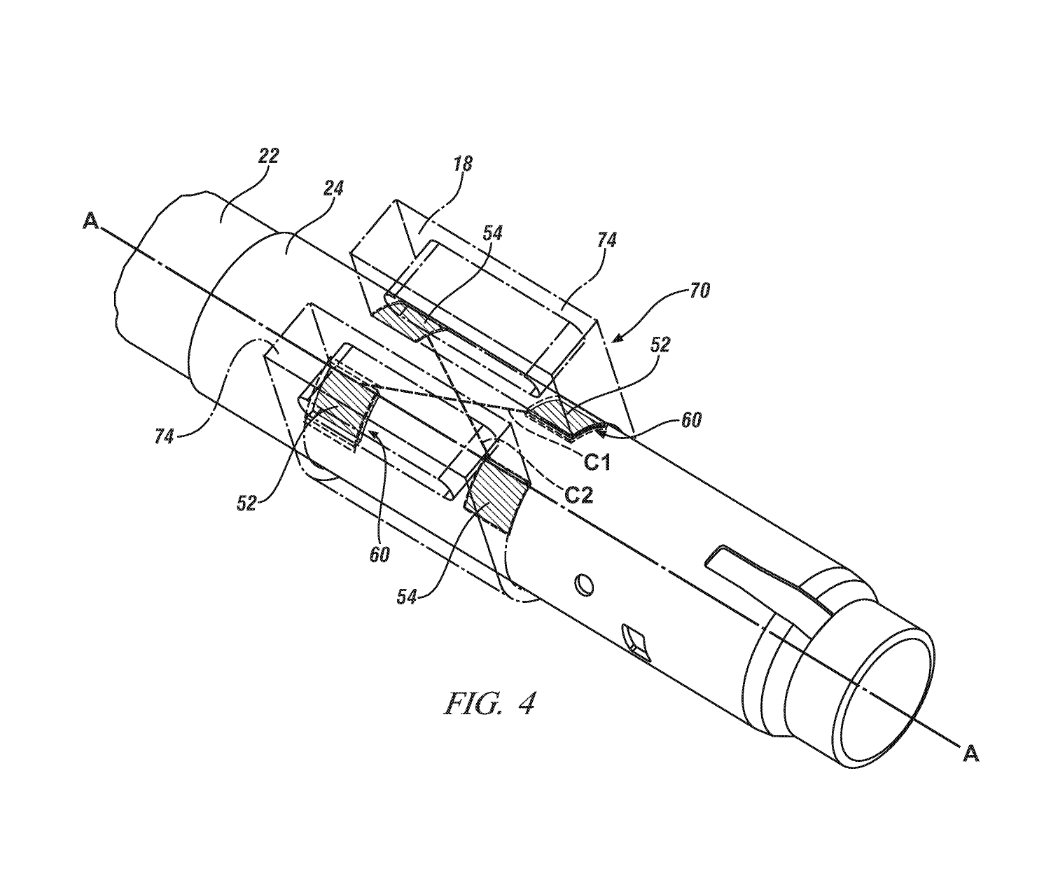

Referring now to FIG. 2, the outer jacket 24 includes at least one aperture 60. The aperture 60 is positioned to receive one of the inner jacket risers 52. Specifically, the inner jacket riser 52 passes through the aperture 60, and frictionally engages with the outer surface 40 of the inner jacket 22 when the compression bracket 18 is compressed in the direction Z. Turning to FIGS. 3-4, in the exemplary embodiment as illustrated the outer jacket 22 may include two generally rectangular apertures 60 that receive one of the inner jacket risers 52. It is understood that while FIGS. 3-4 illustrate the apertures 60 with a generally rectangular profile, it is to be understood that the apertures 60 may include other profiles as well, such as, for example, a generally circular or a generally square profile.

Referring back to FIG. 2, as the compression bracket 18 is compressed by the rake bracket 20 in the direction Z, the inner jacket risers 52 exert a specified frictional force on the inner jacket 22. The specified frictional force is configured for restricting or generally preventing the inner jacket 22 to telescope relative to the outer jacket 24. The specified frictional force in one aspect of the invention, ranges from about 500 N to about 6000 N, is exerted by the inner jacket risers 52 of the compression bracket 18 has to be overcome in order for the inner jacket 22 to telescope relative to the outer jacket 24 in the direction of the longitudinal axis A-A (shown in FIG. 1). In one embodiment, the specified frictional force exerted by the compression bracket 18 may be overcome when a user pushes or pulls on a steering wheel (not shown) of the steering column assembly 10. Alternatively, in another embodiment, the friction force is overcome by an electronically actuated motor (not shown).

Referring generally to FIGS. 2-4, in the exemplary embodiment of the steering column assembly 10 as shown, the compression bracket 18 includes two inner jacket risers 52 and six outer jacket risers 54. However, it is understood that any number of inner jacket risers 52 and outer jacket risers 54 may be used as well. The compression bracket 18 includes a first portion 68 and a second portion 70. The first portion 68 of the compression bracket 18 generally opposes the second portion 70. The first portion 68 of the compression bracket 18 is oriented adjacent to a hinge 73 of the compression bracket 18. The second portion 70 of the compression bracket 18 is oriented to be adjacent to generally opposing end portions 74 of the compression bracket 18. FIGS. 2-4 illustrate the end portions 74 of the generally U-shaped compression bracket 18 are located at the second portion 70 of the steering column assembly 10. In the exemplary embodiment as shown, the first portion 68 is oriented on an upper portion of the steering column assembly 10 in relation to the longitudinal axis A-A of the steering column assembly 10, and the second portion 70 is oriented on a lower portion of the steering column assembly 10 in relation to the longitudinal axis A-A of the steering column assembly 10. However, it is to be understood that the first and second portions 68 and 70 may be oriented along the steering column assembly 10 in other configurations as well.

In the embodiment as shown in FIGS. 2-4, the two inner jacket risers 52 and two of the outer jacket risers 54 are positioned to be on the second portion 70 of the steering column assembly 10. The remaining four outer jacket risers 54 are positioned on the first portion 68 of the steering column assembly 10. Although FIGS. 2-4 illustrate the arrangement of the inner and outer jacket risers 52, 54 as discussed, it is to be understood that other arrangements may be employed as well. Referring specifically to FIG. 4, which is an illustration of the second portion 70 of the steering column assembly 10, the two inner jacket risers 52 are positioned on generally opposing end portions 74 of the compression bracket 18. That is, one of the inner jacket risers 52 is positioned on one of the end portions 74 of the compression bracket 18, and the other inner jacket riser 52 is positioned on the other end portion 74 of the compression bracket 18. The two outer jacket risers 54 are also positioned on generally opposing end portions 74 of the compression bracket 18 as well. The two inner jacket risers 52 are oriented to be generally diagonal with one another, and the two outer jacket risers 54 are also oriented to be generally diagonal with one another as well. That is, the two inner jacket risers 52 are oriented to be in a crosswise configuration with one another relative to the longitudinal axis A-A of the steering column assembly 10. As seen in FIG. 4, a reference line C1 illustrates one of the inner jacket risers 52 that is oriented crosswise with respect to the other of the two inner jacket risers 52 such that reference line C1 intersects the longitudinal axis A-A. The two outer jacket risers 54 are configured to be in a crossways configuration with one another relative to the longitudinal axis A-A of the steering column assembly 10. A reference line C2 illustrates one of the outer jacket risers 54 that is oriented crosswise with respect to the other of the two outer jacket risers 54 such that reference line C2 intersects the longitudinal axis A-A. In other words, each of the two inner jacket risers 52 are positioned to be adjacent to the two outer jacket risers 54. Also, each of the two outer jacket risers 54 are positioned to be adjacent to the two inner jacket risers 52, resulting in a crosswise configuration.

Positioning the inner jacket risers 52 and the outer jacket risers 54 to be generally diagonal or in a crosswise configuration with one another may improve the frictional engagement between the inner jacket 22 and the compression bracket 18. Positioning the inner jacket risers 52 to be generally diagonal with one another may also provide enhanced balance in the steering column assembly 10. It should be noted that in another embodiment the inner jacket risers 52 may be oriented side-by-side with one another, however positioning the inner jacket risers 52 side-by-side with one another may cause an offset along the longitudinal axis A-A between the inner jacket 22 and the outer jacket 24.

Referring now to FIGS. 2 and 4, as the inner jacket risers 52 exert the frictional force on the inner jacket 22 along the second portion 70 of the steering column assembly 10, the inner jacket 22 is pushed or urged in a direction D (shown in FIG. 2), towards the first portion 68 of the steering column assembly 10. Specifically, referring to FIG. 2, as the compression bracket 18 is squeezed or compressed in the direction Z, the inner jacket risers 52 exert a force on the inner jacket 22 in the direction D. The force exerted by the inner jacket risers 52 urges the inner jacket 22 in the direction D such that the inner jacket 22 contacts the outer surface 42 of the outer jacket 24 at a contact point C. The contact point C is located along the first portion 68 of the steering column assembly 10. In the embodiment as shown, the contact point C is located at an apex between the inner jacket 22 and the outer jacket 24.

Although FIG. 2 illustrates the inner jacket risers 52 oriented at the second portion 70 of the steering column assembly 10 at the generally opposing end portions 74 of the compression bracket 18, it is to be understood that the two inner jacket risers 52 may be oriented along the inner surface 56 of the compression bracket 18 in other positions as well. Specifically, the two inner jacket risers 52 may be positioned at any locations around the inner surface 56 of the compression bracket 18. That is, the two inner jacket risers 52 may be positioned at any location around the inner surface 56 of the compression bracket 18 depending on lateral and vertical stiffness requirements of the steering column assembly 10. Positioning the two inner jacket risers 52 closer to the opposing end portions 74 of the compression bracket 18 may enhance lateral stiffness, while positioning the two inner jacket risers 52 further away from the opposing end portions 74 of the compression bracket may enhance vertical stiffness.

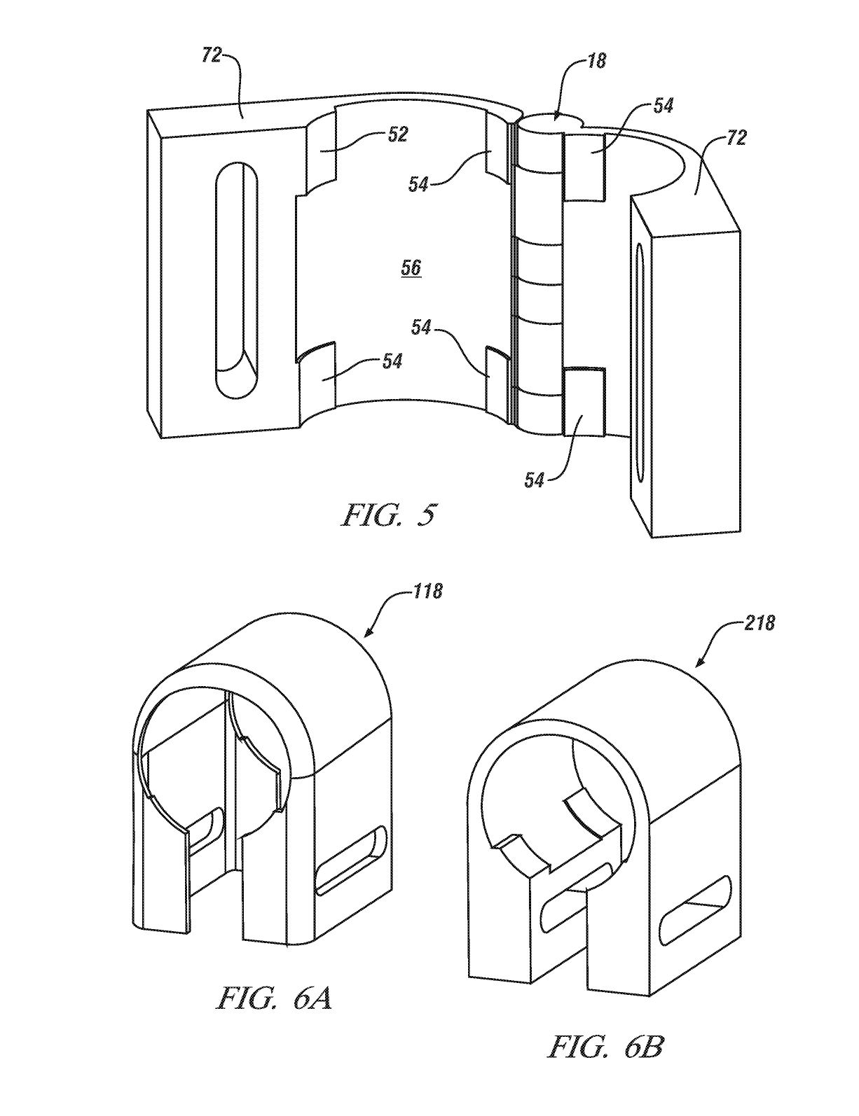

Turning now to FIG. 5, the compression bracket 18 may be constructed from a metal based material such as, for example, a steel alloy. In the embodiment as shown in FIG. 5, the compression bracket 18 is constructed from two half brackets 72, where the half brackets 72 include a generally semi-circular profile. In the embodiment as shown in FIGS. 1-5, the compression bracket 18 may be a metal casting. In one embodiment, the compression bracket 18 may also be an unmachined cast part, which in turn may reduce the cost and complexity of the steering column assembly 10.

The steering column assembly 10 as illustrated generally in FIGS. 1-4 will provide a friction locking device for maintaining a selected position of adjustment between the inner jacket 22 and the outer jacket 24. Unlike some of the steering column assemblies that are currently available, the steering column assembly 10 does not employ a plastic bushing for exerting a frictional force that is overcome to telescope the inner jacket 22 relative to the outer jacket 24. The plastic bushing typically includes some drawbacks. Specifically, if a plastic bushing has a relatively low friction force, then the material stiffness will be adversely affected. Employing a metal based material for the compression bracket 18 may in turn provide improved material stiffness even if a relatively low specified frictional force is employed. Thus, the steering column assembly 10 as described provides for a relatively tight interface when the inner jacket 22 and the outer jacket 24 are locked, and also provides for a relatively low specified frictional force that is needed to telescope the inner jacket 22 relative to the outer jacket 24.

FIGS. 6A and 6B are alternative embodiments of the compression bracket 18. For example, FIG. 6A is an illustration of a compression bracket 118 that is a one-piece bracket. That is, the bracket 118 is a single unitary piece, instead of the approach shown in FIG. 5 where the compression bracket 18 is constructed from two half brackets 72. In the embodiment as shown in FIG. 6A, the compression bracket 118 is a cast part. FIG. 6B is another embodiment of a compression bracket 218. In the embodiment as shown in FIG. 6B, the compression bracket 218 is a stamped part that is constructed from sheet metal. That is, the compression bracket 218 is constructed by one or more sheet metal forming manufacturing processes such as, for example, punching, blanking, embossing, bending, or flanging.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A steering column assembly, comprising:
an inner jacket having an inner jacket outer surface;
an outer jacket having an outer jacket outer surface, the inner jacket slideably disposed in the outer jacket for telescoping movement relative to the outer jacket, the outer jacket having at least one aperture for exposing the inner jacket outer surface; and
a bracket having at least one inner jacket riser and at least one outer jacket riser, the at least one inner jacket riser positioned to be received by the at least one aperture and selectively frictionally engage with the inner jacket outer surface, and the at least one outer jacket riser positioned to selectively frictionally engage with the outer jacket outer surface.

2. The steering column assembly as recited in claim 1, wherein a specified frictional force is exerted by the at least one inner jacket riser if the at least one inner jacket riser is frictionally engaged with the inner jacket outer surface.

3. The steering column assembly as recited in claim 2, wherein the specified frictional force is configured for generally preventing telescoping movement of the inner jacket relative to the outer jacket.

4. The steering column assembly as recited in claim 1, wherein the bracket includes six outer jacket risers and two inner jacket risers.

5. The steering column assembly as recited in claim 4, wherein four of the six outer jacket risers are positioned on one portion of the bracket, and the remaining six outer jacket riser and the two inner jacket risers are positioned on another portion of the bracket that generally opposes the one portion of the bracket.

6. The steering column assembly as recited in claim 5, wherein the two inner jacket risers and two of the six outer jacket risers are positioned on generally opposing end portions of the compression bracket, and wherein the two inner jacket risers are oriented generally diagonal with one another and the two outer jacket risers positioned on the end portions are oriented generally diagonal with one another.

7. The steering column assembly as recited in claim 6, wherein the two inner jacket risers exert a force on the inner jacket, wherein the force urges the inner jacket to contact the outer jacket at a contact point, wherein the contact point is located at an apex between the inner jacket and the outer jacket.

8. The steering column assembly as recited in claim 1, comprising a rake bracket that is engaged with the bracket, wherein the rake bracket selectively compresses the bracket to selectively frictionally engage the at least one inner jacket riser with the inner jacket outer surface and the at least one outer jacket riser with the outer jacket outer surface.

9. The steering column assembly as recited in claim 1, wherein the bracket is comprised of two generally semi-circular brackets.

10. The steering column assembly as recited in claim 1, wherein the bracket is a single unitary part.

11. The steering column assembly as recited in claim 1, wherein the bracket is constructed from a metal based material.

12. The steering column assembly as recited in claim 1, wherein the bracket is a compression bracket configured to be selectively compressed by a rake bracket.

13. A steering column assembly, comprising:
an inner jacket having an inner jacket outer surface;
an outer jacket having an outer jacket outer surface, the inner jacket slideably disposed in the outer jacket for telescoping movement relative to the outer jacket, the outer jacket having at least one aperture for exposing the inner jacket outer surface;
a rake bracket; and
a compression bracket that is selectively compressed by the rake bracket, the compression bracket having at least one inner jacket riser and at least one outer jacket riser, the at least one inner jacket riser positioned to be received by the at least one aperture and frictionally engage with the inner jacket outer surface if the compression bracket is compressed by the rake bracket, and the at least one outer jacket riser positioned to frictionally engage with the outer jacket outer surface if the compression bracket is compressed by the rake bracket, and the at least one inner jacket riser exerting a specified frictional force if the compression bracket is compressed by the rake bracket.

14. The steering column assembly as recited in claim 13, wherein the specified frictional force is configured for generally preventing telescoping movement of the inner jacket relative to the outer jacket.

15. The steering column assembly as recited in claim 13, wherein the bracket includes six outer jacket risers and two inner jacket risers.

16. The steering column assembly as recited in claim 15, wherein four of the six outer jacket risers are positioned on one portion of the bracket, and the remaining six outer jacket riser and the two inner jacket risers are positioned on another portion of the bracket that generally opposes the one portion of the bracket.

17. The steering column assembly as recited in claim 16, wherein the two inner jacket risers and two of the six outer jacket risers are positioned on generally opposing end portions of the compression bracket, and wherein the two inner jacket risers are oriented generally diagonal with one another and the two outer jacket risers positioned on the end portions are oriented generally diagonal with one another.

18. The steering column assembly as recited in claim 17, wherein the two inner jacket risers exert a force on the inner jacket, wherein the force urges the inner jacket to contact the outer jacket at a contact point, wherein the contact point is located at an apex between the inner jacket and the outer jacket.

19. An assembly, comprising:
an inner jacket having an inner jacket outer surface;
an outer jacket having an outer jacket outer surface, the inner jacket slideably disposed in the outer jacket for telescoping movement relative to the outer jacket, the outer jacket having at least one aperture for exposing the inner jacket outer surface; and
a bracket having at least one inner jacket riser and at least one outer jacket riser, the at least one inner jacket riser positioned to be received by the at least one aperture and selectively frictionally engage with the inner jacket outer surface, and the at least one outer jacket riser positioned to selectively frictionally engage with the outer jacket outer surface.

20. The assembly as recited in claim 19, wherein a specified frictional force is exerted by the at least one inner jacket riser if the at least one jacket riser is frictionally engaged with the inner jacket outer surface, and wherein the specified frictional force is configured for generally preventing telescoping movement of the inner jacket relative to the outer jacket.
